(19) United States
(12) Patent Application Publication
(10) Pub. No.: US 2020/0021090 A1
(43) Pub. Date: Jan. 16, 2020

(54) INTEGRATED CABLE TRAY AND SKID ASSEMBLY

(71) Applicant: SCHNEIDER ELECTRIC IT CORPORATION, West Kingston, RI (US)

(72) Inventors: William Eugene Ziegler, Methuen, MA (US); Michael Thomas Sweet, McKinney, TX (US)

(21) Appl. No.: 16/507,831

(22) Filed: Jul. 10, 2019

Related U.S. Application Data
(60) Provisional application No. 62/696,354, filed on Jul. 11, 2018.

(51) Int. Cl. H02G 3/04; B65D 71/00

(52) U.S. Cl. CPC H02G 3/0406; H02G 3/0456; H02G 3/045; B65D 71/0092

(57) ABSTRACT

A modular skid assembly is disclosed. The modular skid assembly includes a skeletal framework configured to house electrical equipment components and support power cables routed between the electrical equipment components, wherein the skeletal framework is configured to house electrical components in two parallel rows with an aisle between the two parallel rows, the skeletal framework including an upper superstructure, a lower superstructure, and one or more vertical columns connected between the upper superstructure and the lower superstructure. The upper superstructure includes a first horizontal support and a second horizontal support. The upper superstructure includes a lower cable tray having a plurality of tray supports fixed to at least one of the first horizontal support and the second horizontal support and extending over the aisle from the first horizontal support towards the second horizontal support. The lower cable tray includes a plurality of rungs fixed to a first of the plurality of tray supports and a second of the plurality of tray supports.

### CROSS-REFERENCE TO RELATED APPLICATION

This application claims priority to U.S. Provisional Application Ser. No. 62/696,354, titled “Integrated Cable Tray and Skid Assembly,” filed on Jul. 11, 2018, which is incorporated herein by reference in its entirety.

### BACKGROUND OF INVENTION

### Field of the Invention

The present disclosure is directed to a modular skid assembly for pre-fabricated (pre-fab) data center modules that include electrical components arranged on a platform and are shipped to an end-use site.

### Discussion of Related Art

Pre-fabricated data center modules typically require a platform or enclosure on which to mount electrical components. Further, such modules may additionally utilize overhead and underfloor cabling systems such as conduits, raceways and cable trays. Such systems are generally supplied as a set of straight sections, radius sections, transition fittings, connectors, hangers, supports, seismic braces and grounding fittings. These various pieces need to be cut, fit, assembled and installed into the skid system. Such installation generally requires structural supports on the skid to support the cable tray system Grounding connections and leads may be attached to the tray system to form an equi-potential ground between all parts of the cable tray system and the skid structure. As a result, skids generally require significant pre-assembly to cut, fit, re-cut, assemble, and secure such cabling system before any equipment can be installed, substantially increasing the deployment time, cost, and complexity of a pre-fabricated solution.

### SUMMARY

An integrated cable tray and modular skid assembly is disclosed. An integrated cable tray and modular skid assembly may comprise, a skeletal framework that acts as a cable routing and an equipment support structure, the skeletal framework including an upper superstructure and a lower superstructure and one or more vertical columns connected between the upper superstructure and the lower superstructure, wherein the upper superstructure includes an upper cable tray and a lower cable tray, wherein formation of the lower cable tray includes one or more straight angled supports are operatively connected to one or more steel tube rungs which are operatively connected to one or more lower flanges of a transverse angled T shape structural beam.

One aspect is directed to a modular skid assembly. The modular skid assembly includes a skeletal framework configured to house electrical equipment components and support power cables routed between the electrical equipment components, wherein the skeletal framework is configured to house electrical components in two parallel rows with an aisle between the two parallel rows, the skeletal framework including an upper superstructure, a lower superstructure, and one or more vertical columns connected between the upper superstructure and the lower superstructure. The upper superstructure includes a first horizontal support and a second horizontal support. The upper superstructure includes a lower cable tray having a plurality of tray supports fixed to at least one of the first horizontal support and the second horizontal support and extending over the aisle from the first horizontal support towards the second horizontal support. The lower cable tray includes a plurality of rungs fixed to a first of the plurality of tray supports and a second of the plurality of tray supports.

The modular skid assembly may further include electrical equipment components coupled to the skeletal structure, and the modular skid assembly may also include a first power cable coupled to a first electrical equipment component in a first row of the two parallel rows and coupled to a second electrical equipment component in a second row of the two parallel rows, wherein the first power cable is routed from the first electrical equipment component to the second electrical equipment component using the lower cable tray. The modular skid assembly may further include an upper cable tray positioned above the lower cable tray, and a second power cable coupled to a third electrical equipment component in a first row of the two parallel rows and coupled to a fourth electrical component in the first row of the two parallel rows, and the second power cable may be routed from the third electrical equipment component to the fourth electrical equipment component using the upper cable tray. The upper cable tray may be mounted on and electrically coupled to at least one of the plurality of tray supports of the lower cable tray, and the upper cable tray may be coupled to and mounted on an upper support of the skeletal assembly. At least one part of the lower cable tray may be welded to a support of the upper superstructure, and the plurality of rungs may welded to the first plurality of tray supports and the second plurality of tray supports. In the modular skid assembly, the aisle may have a length that is substantially parallel to the two parallel rows, and the modular skid assembly may include electrical equipment components mounted in the rows, each of the electrical equipment components having a front panel facing the aisle. Each of the first horizontal support and the second horizontal support may have a length parallel to the length of the aisle.

Another aspect is directed to a method of manufacturing a modular skid assembly. The method includes assembling a skeletal framework configured to house electrical equipment components and support power cables routed between the electrical equipment components, wherein the skeletal framework is configured to house electrical components in two parallel rows with an aisle between the two parallel rows, wherein an upper portion of the skeletal framework includes a first horizontal support and a second horizontal support, each of the first horizontal support and the second horizontal support, mounting a lower cable tray to an upper portion of the skeletal framework, the lower cable tray having a plurality of tray supports, wherein mounting includes fixing the plurality of tray supports to at least one of the first horizontal support and the second horizontal support, such that the plurality of supports extends over the aisle from the first horizontal support to the second horizontal support.

The method may further include installing electrical equipment components in the skeletal framework, and may include coupling a first power cable to a first electrical equipment component in a first row of the two parallel rows, routing the first power cable from the first electrical equipment component to a second electrical equipment component in a second row of the two parallel rows using the lower cable tray, and coupling the first power cable to the second electrical equipment component. The method may include shipping the skeletal framework with the lower cable tray, electrical equipment components and the first power cable to an installation site. The method may include mounting an upper cable tray above the lower cable tray, and may include coupling a second power cable to a third electrical equipment component in a first row of the two parallel rows, routing the second power cable from the third electrical equipment component to a fourth electrical component in a second row of the two parallel rows using the upper cable tray, and coupling the second power cable to the fourth electrical equipment component. In the method, mounting the upper cable tray may include electrically coupling the upper cable tray to at least one of the plurality of tray supports of the lower cable tray. The method may further include welding the lower cable tray to a support of the upper superstructure.

Another aspect is directed to a modular skid assembly. The modular skid assembly includes a skeletal framework configured to house electrical equipment components and support power cables routed between the electrical equipment components, wherein the skeletal framework includes lower horizontal support members, upper horizontal support members and vertical support members, one or more of the vertical support members extending from one of the lower horizontal support members to one of the upper support members, wherein the skeletal framework includes a plurality of rungs fixed between a first support member of the upper horizontal support members and a second support member of the upper support members to form a first cable tray in the skeletal framework, a plurality of electrical equipment components mounted in the skeletal framework and arranged in two parallel rows, including a first row and a second row. with an aisle between the two parallel rows, and a power cable coupled to a first electrical equipment component of the plurality of electrical equipment components in the first row and coupled to a second electrical component of the plurality of electrical equipment components in the second row, and wherein the power cable is routed from the first electrical equipment component to the second electrical equipment component using the first cable tray.

The modular skid assembly may further include a second cable tray mounted to the first of the upper horizontal support members, and each of the plurality of rungs may welded to the first support member and the second support member.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments and are incorporated in and constitute a part of this specification but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a perspective view of an example integrated cable tray and skid assembly;

FIG. 2 is a rear view of the integrated cable tray and skid assembly of FIG. 1, with a representative number of power cables shown;

FIG. 3 is a reverse perspective view of the integrated cable tray and skid assembly of FIG. 1;

FIG. 4 is a view of the integrated cable tray and skid assembly of FIG. 1, with an upper cable tray and associated cables removed;

FIG. 5 is a perspective view of the integrated cable tray and skid assembly of FIG. 1, with equipment components, the upper cable tray, and power cables removed;

FIG. 6 is a view of the integrated cable tray and skid assembly of FIG. 5;

FIG. 7 is an exploded view of an integrated cable tray of the integrated cable tray and skid assembly of FIG. 6.

FIG. 8 is a view of a second example of an integrated cable tray and supporting structure that can be used in the skid assembly of FIG. 1 in place of the integrated cable tray of FIG. 7.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are no intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

The present disclosure relates generally to a skid for supporting electrical components and associated cabling both during shipping of the electrical components and during use of the electrical components at the site of the end user. Specifically, embodiments of the present disclosure are described with reference to a modular skid assembly that has a platform and a cable management assembly to support electrical components and associated cabling during use by the end user and at least one stabilizing structure to support the platform during hoisting, positioning, and transporting of the platform. At least one embodiment of a modular skid assembly of the present disclosure is monolithic in nature with both component support and cable management assembled before shipment and installation at a user facility.

In at least one example, a cabling management assembly is an integrated part of the supporting structure of a modular skid assembly and not separate components that need to be supported and secured. Embodiments of the disclosure include an embedded cable tray design which utilizes overhead structural support beams as rails of a ladder style tray with rungs of the ladder welded, or otherwise permanently fastened, directly between the beams. Embodiments disclosed herein may provide various benefits. First, for example, at least some embodiments result in a reduced total height of the skid solution, compared to traditional solutions, as the cable tray and support structure are integrated into the skid assembly, rather than mounted on top of the skid assembly. A reduced height is beneficial in various embodiments in that the reduced height may eliminate the need for extra time and expense for special transport routes and extra shipping costs.

Second, for example, in some embodiments, simplification of the design results in the elimination of a number of parts and steps required for the manufacture of a commercially available cable tray. This simplification reduces part count, assembly steps, and reduces the occurrence of assembly errors. As a result, this increases throughput of a manufacturing facility of the skid assembly factory by elimination of many assembly steps. In prefabricated skid production this is a critical issue, due to very limited workspace on a typical skid for multiple personnel and trades to be working simultaneously. Any step eliminated or moved away from the final skid assembly process improves factory throughput speed and results in a cost savings.

Third, for example, in at least some embodiments, more robust mechanical support of the cables may result in the elimination of the requirement for additional seismic bracing. In embodiments, the mounting of cables directly to rungs welded to the structure of the skid is many times sturdier than hanging or clamping typical commercially available cable trays to the structure.

Fourth, for example, in some embodiments, grounding is inherent in the design through the use of welds or other permanent fastening methods that provide electrical conductivity between connecting parts. The conductive fastening may eliminate the need to add extra ground straps to connect cable tray components to the skid. This results both in reduced cost and additional reliability and performance.

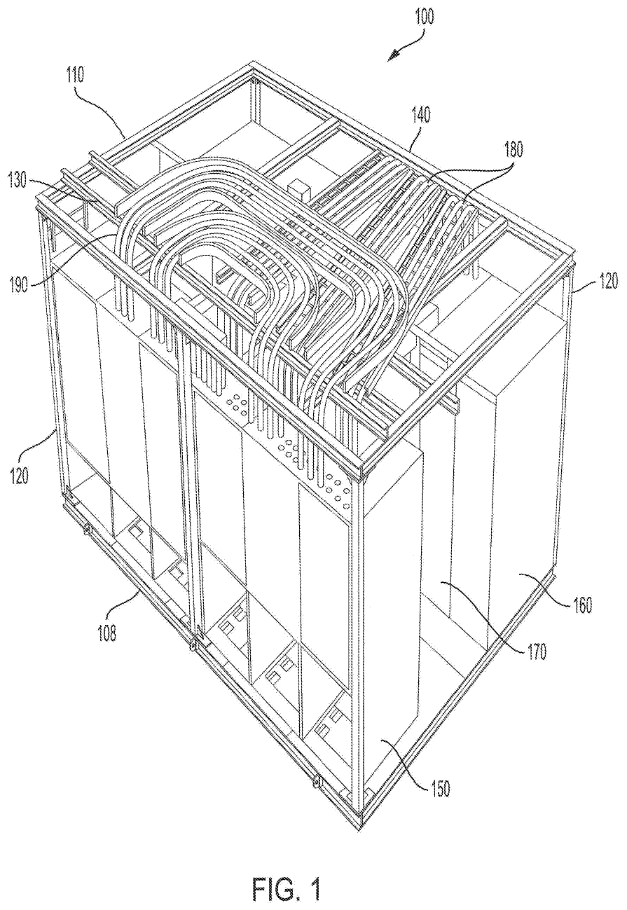

FIG. 1 illustrates a perspective view of an example skid assembly 100 having an integrated cable tray assembly in accordance with various embodiments of the disclosure. The skid assembly 100 is a pre-fabricated module with a lower superstructure 108 operatively connected to an upper superstructure 110 through the use of a plurality of vertical support columns 120. It should be appreciated that while the support columns are described as vertical, a variety of configurations are contemplated that may not be vertical or may be nearly vertical. Such supports may consist of several components to assemble into a support column and need not be a single support structure. Further, such supports are utilized for the purpose of providing support for and connecting the lower superstructure 108 to the upper superstructure 110. The connection of the lower superstructure 108 to the upper superstructure through the vertical support columns 120 forms a skeletal frame. The dimensions of this skeletal frame are various and based on the application.

The upper superstructure 110 has an upper cable tray 130 operatively fastened via bolts or similar hardware to the upper superstructure 110. The upper cable tray 130 is assembled on top of the upper superstructure 110. The upper cable tray 130 may be present in various embodiments and not utilized in others. Further, while one example of an upper cable tray is illustrated, in other embodiments, the upper cable tray 130 may be configured differently depending on cable routing configurations needed. Various pieces used to construct the upper cable tray 130 may be cut, fit, assembled and installed into the skid assembly 100 based on the cable routing configurations. The upper cable tray 130 is mounted to structural supports on the upper superstructure 110. Grounding connections and leads may be attached to the upper cable tray 130 to form an equi-potential ground between all parts of the upper cable tray and the skid assembly 100. Typically, the weight of power cables contained in cable trays, such as the upper cable tray 130, may require the upper cable tray to be supported by structural elements of the skid assembly 100. As discussed below, in at least some embodiments, a lower cable tray is integrated in the structure of the skid assembly 100 and is manufactured using structural steel enabling the lower cable tray to provide sufficient mechanical support for the upper cable tray 130.

The upper superstructure 110 has a lower cable tray 140 operatively integrated into the upper superstructure 110. It is noteworthy that the lower cable tray 140, in at least some embodiments is both operatively connected and may be planar to the upper superstructure 110, with a top of the lower cable tray 140 being at the same height as other structural components of the skid assembly. In this manner, the addition of the lower cable tray 140 does not increase the overall height of the skid assembly 100. In other embodiments, the lower cable tray 140 may be positioned above or below the plane of the top of the upper superstructure 110.

Connections between the lower super structure 108, upper superstructure 110, vertical support columns 120, and upper cable tray 130 is accomplished in at least some embodiments through bolts or similar fastener methods and devices. The lower cable tray 140 in at least one embodiment is integrated within and fixed to the upper superstructure 110 via welding or other permanent method or accomplished through bolts or similar fastener methods and devices to form a monolithic skeletal structure for the skid assembly 100 which includes the integrated cable tray 140. The upper cable tray 130 and/or the lower cable tray 140 may form or utilize cable ladders and are useful to guide cables from an external power supply or other external electrical components to the electrical components that are supported on the platform as generally illustrated in FIGS. 1, 2, 3, and 4 and described in further detail below. Further, the cable trays may be used to guide cables between components contained within the skid assembly 100.

The lower super structure 108 supports a first row 150 and a second row 160 of electrical components. These components may include but are not limited to one or more battery cabinets, battery breaker control boxes, uninterruptible power supply (UPS) cabinets, input switchgear cabinets, and/or output switchgear cabinets. As shown in FIG. 1, the first row 150 and the second row 160 are arranged in parallel in the skid assembly 100 and are separated by an aisle 170. The skid assembly includes a first set of cables 180 that are routed from components in the first row 150 through the lower cable tray 140 to components in the second row 160. The skid assembly also includes a second set of cables 190 that are routed between components in the first row 150 through the upper cable tray 130. In other embodiments, both the upper cable tray 130 and the lower cable tray 140 may be configured to provide cable routing between other components in both the first row 150 and the second row 160.

Other components may also be operatively connected to the skeletal structure of the skid assembly. One example may be shipping straps which may be secured at various parts of the skeletal structure. The shipping straps improve stability of the skeletal structure during hoisting, positioning, and transporting of the skeletal structure.

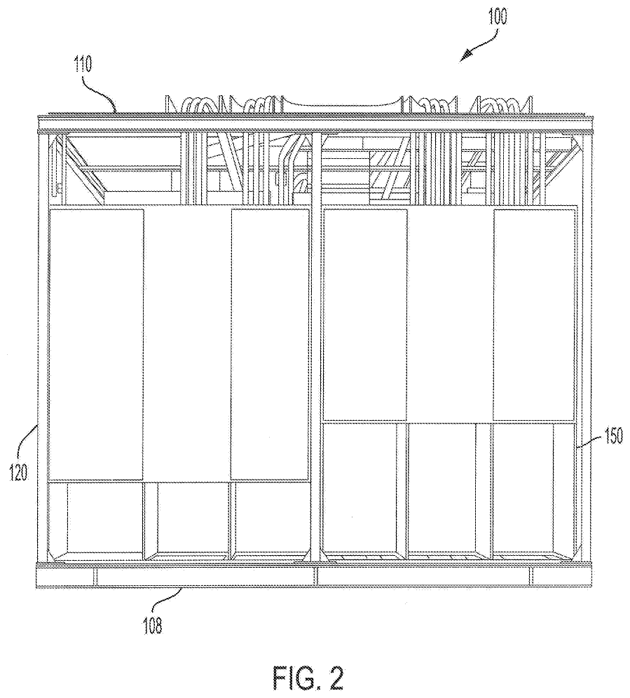

FIG. 2 illustrates a rear view of the skid assembly 100 in accordance with various embodiments of the disclosure.

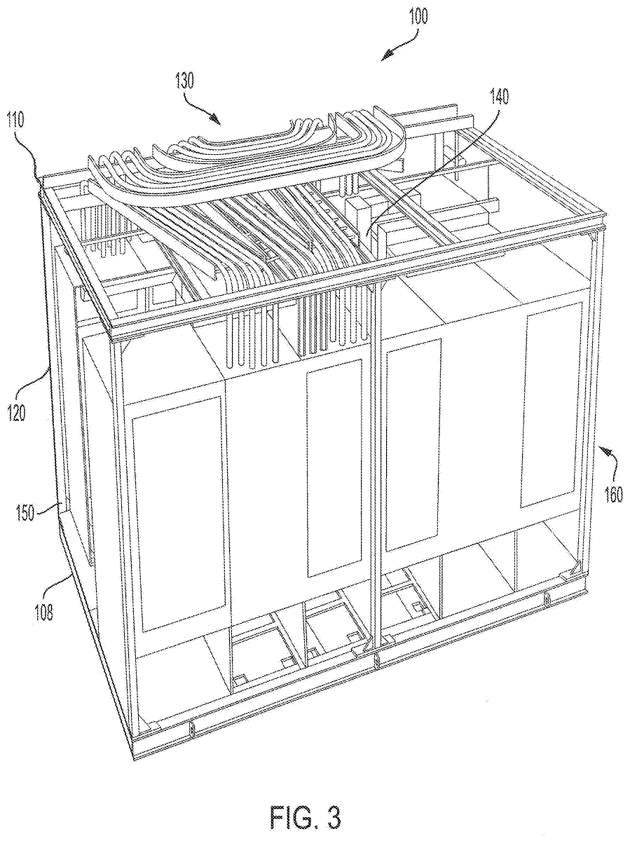

FIG. 3 illustrates a reverse perspective view of the skid assembly 100 in accordance with various embodiments of the disclosure, with a representative number of power cables shown in further detail from FIG. 1.

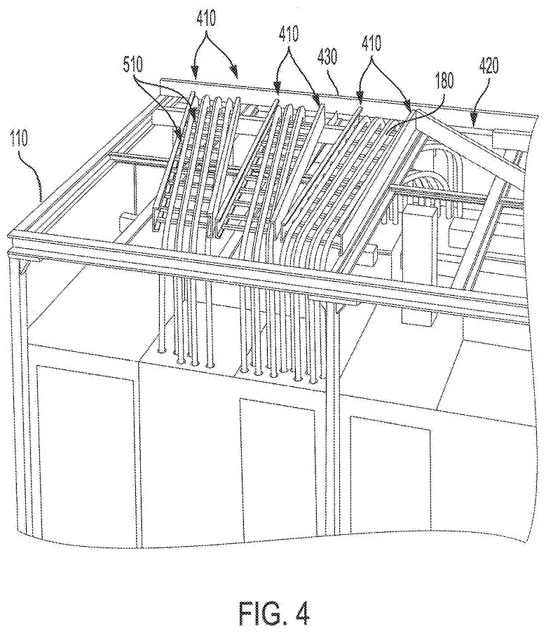

FIG. 4 illustrates a partially exploded view of the skid assembly 100 in accordance with various embodiments of the disclosure, with a representative number of power cables shown, and the upper cable tray 130 removed. The plurality of cables 180 interconnecting the first row 150 and the second row 160 of electrical components can be seen in FIG. 4 exiting the lower cable tray 140 and passing into the electrical components of the second row 160. The number of cables and interconnects are various based on the application, electrical components, and usage of the skid assembly 100.

As shown in FIG. 4, the lower cable tray 140 includes cable tray guides 410 assembled in pairs in approximately parallel fashion and welded or otherwise permanently attached to the upper superstructure 110 and supported by members of the upper structure 110. The cable tray guides 410 are further supported by constitute members of the upper superstructure 110. Cable tray rungs 510 are welded between each pair of cable tray guides 410 to form cable ladders to support the cables associated with the electrical components.

The number of cable tray guides 410 and cable tray rungs 510 may vary greatly based on the particular application. It also should be appreciated that it is not necessary to use pairs of cable tray guides 410 to form the cable ladders. As an example, the use of three cable tray guides 410 with cable tray rungs 510 welded between each may yield two cable ladders. Further, the distance between the cable tray rungs 510 may vary based on the application and space availability. In at least one embodiment, the cable tray guides 410 and the cable tray rungs are constructed from structural steel such as hot rolled sections of ASTM A36 or ASTM A53.

A variety of additional, optional, support beams may be used in the upper superstructure 110 depending on the application. Such support beams serve multiple purposes including support of the upper superstructure 110, support of the skeletal frame, support of the lower cable tray 140, and support of the upper cable tray 130. In the embodiment shown in FIG. 4, two additional support beams are used, including support beam 430 and angular support beam 420. The support beam 430 and the angular support beam 420, in conjunction with the cable tray guides 410 can be used to support the upper cable tray 130.

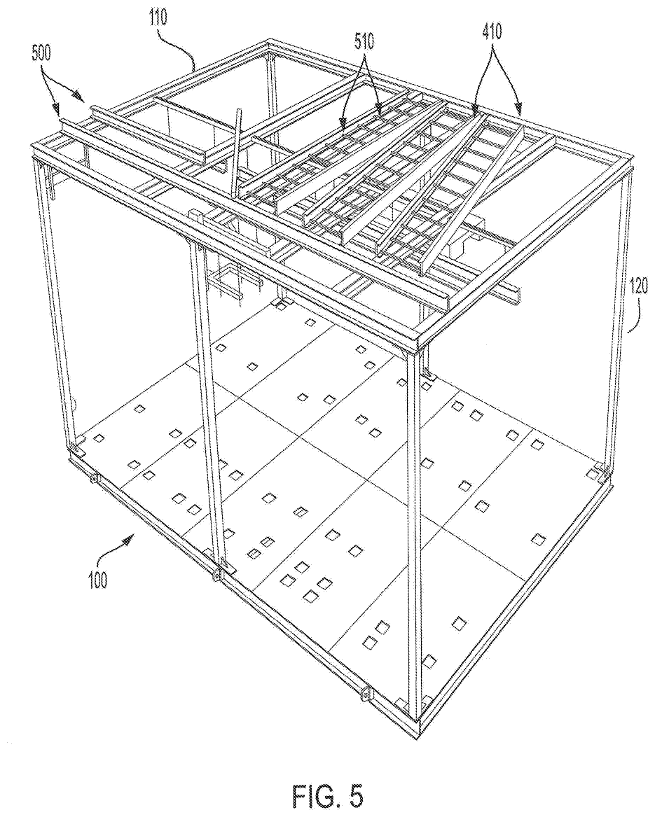

FIG. 5 illustrates a perspective view of the skid assembly 100, with the electrical equipment, upper cable tray 130, support beam 430 and power cables 180 removed. Additional, optional, cross rail cable tray support beams 500 are also shown. As with the angular support beam 420, multiple purposes may be served by the cable tray support beams 500, including support of the upper superstructure 110, support of the skeletal frame, support of the upper cable tray 130, and/or support of the lower cable tray 140.

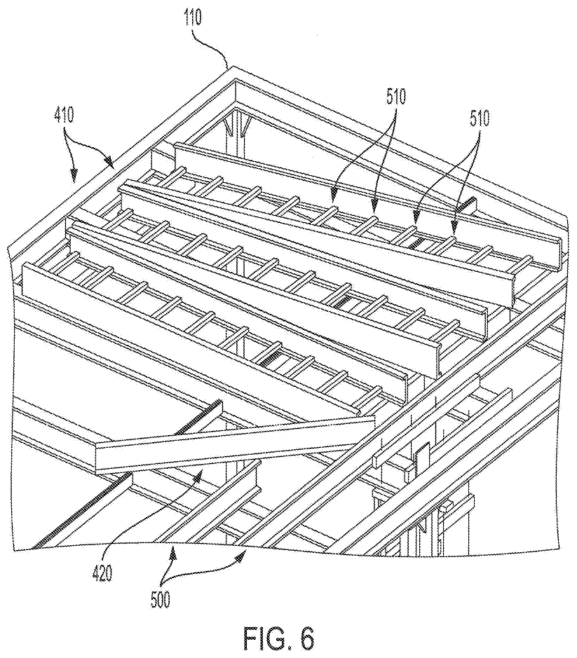

FIG. 6 illustrates a partially exploded view of the skid assembly 100 with the electrical equipment, upper cable tray 130, support beam 430 and power cables 180 removed.

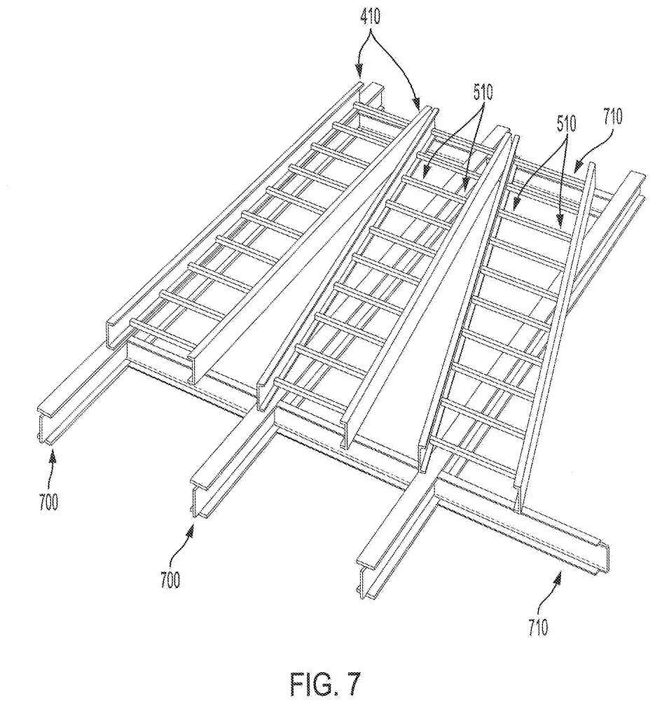

FIG. 7 illustrates an exploded view of a portion of the upper structure 110 and lower cable tray 140 of the skid assembly 100 with the electrical equipment components, upper cable tray 130, support beam 430, angular support beam 420, support beams 500 and power cables 180 removed. A series of rail cable tray supports 700 are utilized and operatively connected to a series of cross rail cable tray supports 710. The rail cable tray supports 700 and 710 are used to support the upper superstructure 110, the skeletal frame, the upper cable tray 130, the lower cable tray 140.

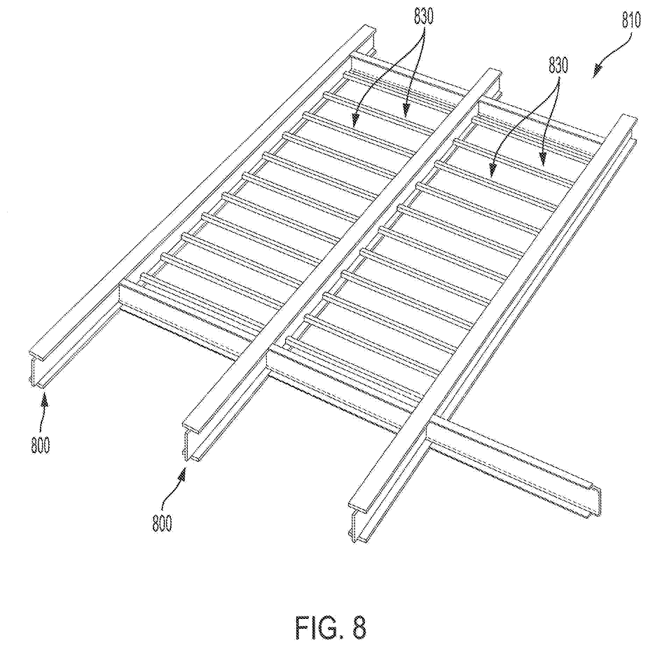

FIG. 8 illustrates an exploded view of an upper structure 810 that may be used in an alternative embodiment of the skid assembly 100. In FIG. 8, the electrical equipment components, upper cable tray 130, support beam 430, angular support beam 420, support beams 500 and power cables 180 are removed for clarity. In the alternative embodiment shown in FIG. 8, the remainder of the skid assembly 100 may be substantially the same as described above. In the embodiment of FIG. 8, cross rail cable supports 800 act as cable tray guides, and the cable tray guides 410 used above are not needed. Rungs 830 are welded or otherwise permanently coupled to the cross rail cable supports 800 to create a lower integrated cable tray. Also shown in FIG. 8 are cross rail supports 820 that run substantially perpendicular to the cross rail cable supports 800 to provide further structural support for the skid assembly. To allow cables in the integrated cable tray to pass over the cross rail supports 820 without extending above the top of the cross rail supports 800, in some embodiments, the cross rail supports 820 may be narrower than the cross rail supports 800 or notched in the areas between the cross rail supports 800. The integrated lower cable tray in the embodiment shown in FIG. 8 provides additional benefits of lowering the overall height of the skid assembly and reducing the total number of components needed and thus material costs. One or more upper cable trays, as described above, may be installed on the cross rail supports 800 and 820.

In one embodiment, the skid assembly 100, shown in FIG. 1 is fabricated in an assembly plant and then shipped to an installation facility, such as a data center. The use of an integrated cable tray assembly allows the skid assembly to be fully manufactured at the assembly plant and shipped to the installation site fully assembled or nearly-fully assembled. At the installation site, the skid assembly can be easily installed in a facility and ready for operation in less time and with less effort than with typical prior assemblies.

In at least some embodiments, as described above, support beams used in skid assemblies are implemented using steel I-beams. In other embodiments other types of beams may be used. It should be appreciated these beams may be of various sizes, shapes, and angulations (e.g. transverse angulations) to accomplish the purposes stated herein.

Having thus described several aspects of at least one embodiment, it is to be appreciated various alterations, modifications, and improvements will readily occur to those skilled in the art. Such alterations, modifications, and improvements are intended to be part of this disclosure and are intended to be within the scope of the disclosure. Accordingly, the foregoing description and drawings are by way of example only.

1. A modular skid assembly, comprising:
a skeletal framework configured to house electrical equipment components and support power cables routed between the electrical equipment components, wherein the skeletal framework is configured to house electrical components in two parallel rows with an aisle between the two parallel rows, the skeletal framework including an upper superstructure, a lower superstructure, and one or more vertical columns connected between the upper superstructure and the lower superstructure;
wherein the upper superstructure includes a first horizontal support and a second horizontal support;
wherein the upper superstructure includes a lower cable tray having a plurality of tray supports fixed to at least one of the first horizontal support and the second horizontal support, and extending over the aisle from the first horizontal support towards the second horizontal support; and
wherein the lower cable tray includes a plurality of rungs fixed to a first of the plurality of tray supports and a second of the plurality of tray supports.

2. The modular skid assembly of claim 1, further comprising electrical equipment components coupled to the skeletal structure.

3. The modular skid assembly of claim 2, further comprising a first power cable coupled to a first electrical equipment component in a first row of the two parallel rows and coupled to a second electrical equipment component in a second row of the two parallel rows, and wherein the first power cable is routed from the first electrical equipment component to the second electrical equipment component using the lower cable tray.

4. The modular skid assembly of claim 1, further comprising an upper cable tray positioned above the lower cable tray.

5. The modular skid assembly of claim 4, further comprising a second power cable coupled to a third electrical equipment component in a first row of the two parallel rows and coupled to a fourth electrical component in the first row of the two parallel rows, and wherein the second power cable is routed from the third electrical equipment component to the fourth electrical equipment component using the upper cable tray.

6. The modular skid assembly of claim 5, wherein the upper cable tray is mounted on and electrically coupled to at least one of the plurality of tray supports of the lower cable tray.

7. The modular skid assembly of claim 6, wherein the upper cable tray is further coupled to and mounted on an upper support of the skeletal assembly.

8. The modular skid assembly of claim 1, wherein at least one part of the lower cable tray is welded to a support of the upper superstructure, and the plurality of rungs are welded to the first plurality of tray supports and the second plurality of tray supports.

9. The modular skid assembly of claim 1, wherein the aisle has a length that is substantially parallel to the two parallel rows, and the modular skid assembly includes electrical equipment components mounted in the rows, each of the electrical equipment components having a front panel facing the aisle.

10. A method of manufacturing a modular skid assembly, the method comprising:
assembling a skeletal framework configured to house electrical equipment components and support power cables routed between the electrical equipment components, wherein the skeletal framework is configured to house electrical components in two parallel rows with an aisle between the two parallel rows, wherein an upper portion of the skeletal framework includes a first horizontal support and a second horizontal support, each of the first horizontal support and the second horizontal support;
mounting a lower cable tray to an upper portion of the skeletal framework, the lower cable tray having a plurality of tray supports, and wherein mounting includes fixing the plurality of tray supports to at least one of the first horizontal support and the second horizontal support, such that the plurality of supports extends over the aisle from the first horizontal support to the second horizontal support.

11. The method of claim 10, further comprising installing electrical equipment components in the skeletal framework.

12. The method of claim 11, further comprising coupling a first power cable to a first electrical equipment component in a first row of the two parallel rows, routing the first power cable from the first electrical equipment component to a second electrical equipment component in a second row of the two parallel rows using the lower cable tray, and coupling the first power cable to the second electrical equipment component.

13. The method of claim 12, further comprising shipping the skeletal framework with the lower cable tray, electrical equipment components and the first power cable to an installation site.

14. The method of claim 10, further comprising mounting an upper cable tray above the lower cable tray.

15. The method of claim 14, further comprising coupling a second power cable to a third electrical equipment component in a first row of the two parallel rows, routing the second power cable from the third electrical equipment component to a fourth electrical component in a second row of the two parallel rows using the upper cable tray, and coupling the second power cable to the fourth electrical equipment component.

16. The modular skid assembly of claim 14, wherein mounting the upper cable tray includes electrically coupling the upper cable tray to at least one of the plurality of tray supports of the lower cable tray.

17. The modular skid assembly of claim 10, further comprising welding the lower cable tray to a support of the upper superstructure.

18. A modular skid assembly, comprising:
a skeletal framework configured to house electrical equipment components and support power cables routed between the electrical equipment components, wherein the skeletal framework includes lower horizontal support members, upper horizontal support members and vertical support members, one or more of the vertical support members extending from one of the lower horizontal support members to one of the upper support members, wherein the skeletal framework includes a plurality of rungs fixed between a first support member of the upper horizontal support members and a second support member of the upper support members to form a first cable tray in the skeletal framework;
a plurality of electrical equipment components mounted in the skeletal framework and arranged in two parallel rows, including a first row and a second row. with an aisle between the two parallel rows; and
a power cable coupled to a first electrical equipment component of the plurality of electrical equipment components in the first row and coupled to a second electrical component of the plurality of electrical equipment components in the second row, and wherein the power cable is routed from the first electrical equipment component to the second electrical equipment component using the first cable tray.

19. The modular skid assembly of claim 18, further comprising a second cable tray mounted to the first of the upper horizontal support members.

20. The modular skid assembly of claim 19, wherein each of the plurality of rungs is welded to the first support member and the second support member.
